(19) United States
(12) Patent Application Publication
(10) Pub. No.: US 2020/0071530 A1
(43) Pub. Date: Mar. 5, 2020

(54) UNITARY MAT HAVING INCREASED GREEN STRENGTH AND METHOD OF FORMING THE SAME

(71) Applicant: SOLENIS TECHNOLOGIES, L.P., Wilmington, DE (US)

(72) Inventor: Michael J. Birkeland, Wilmington, DE (US)

(73) Assignee: SOLENIS TECHNOLOGIES, L.P., Wilmington, DE (US)

(21) Appl. No.: 16/118,027

(22) Filed: Aug. 30, 2018

(51) Int. Cl. C08L 97/02

(52) U.S. Cl. CPC C08L 97/02; C08L 2205/03

(57) ABSTRACT

A unitary mat includes a plurality of lignocellulosic particles and an adhesive chosen from an isocyanate, phenol formaldehyde, polyamino amido epichlorohydrin, and combinations thereof. The adhesive is present in an amount of from about 1 to about 10 percent by weight based on 100 parts by weight of dry lignocellulosic particles. The unitary mat also includes a proteinaceous powder having a protein dispersibility index of from about 1 to about 90 and present in an amount of from about 0.5 to about 10 percent by weight based on 100 parts by weight of dry lignocellulosic particles, and an aqueous diluent present in an amount of from about 0.5 to about 10 percent by weight based on 100 parts by weight of dry lignocellulosic particles. The unitary mat may also have a green strength tack test result of greater than 3 inches.

### TECHNICAL FIELD

The present invention generally relates to a unitary mat having increased green strength. More specifically, this disclosure relates to a unitary mat having lignocellulosic particles, an adhesive, a proteinaceous powder, and an aqueous diluent, and a method of forming the mat.

### BACKGROUND

Mats such as oriented strand board (OSB), oriented strand lumber (OSL), particleboard (PB), scrimber, agrifiber board, chipboard, flakeboard, and fiberboard, e.g. medium density fiberboard (MDF), are generally produced by blending or spraying lignocellulosic material with a binder while being mixed in a blender. After blending, the lignocellulosic material is typically coated with the binder and formed into a mat via compression. This compression can be cold and described as cold press or can include heat wherein the blended material is compressed between heated platens/plates to set the binder and to bond the lignocellulosic material together in densified form, such as in a board, panel, or other shapes.

Depending upon the type of mill operation, e.g., whether a continuous or cauled process is employed in the production of particleboard, the degree of cohesiveness of the mat formed from the wood particles or “furnish” needed to maintain its shape and integrity as it moves along the conveyor prior to compression may vary. Binders that have been used for making such mats tend to produce undesirable emissions. To improve on this process, methylene diphenyl diisocyanate (MDI) has been used.

Traditional urea-formaldehyde binders are known to impart some cold tack or wood particle cohesion to the mat such that relatively high production rates can be achieved. However, MDI is typically unsuitable for use in continuous production processes because it does not allow the lignocellulosic material, as the mat, to remain intact on a continuous process line. More specifically, vibrations and one or more gaps between conveyor belts tend to destroy the integrity of the mats thereby eventually resulting in defective boards after compression. Quite simply, mats made with MDI tend to fall apart when produced on/in a continuous process line. In other words, mat integrity is not maintained under some of the more severe continuous mill processing conditions. In such situations, there may be gaps along the conveyor as the mat is lowered from one level to another on its way to the final press. The mat must be sufficiently strong so that it will not collapse under its own weight as it extends over the gap before coming in contact with the next belt. Accordingly, it is desirable to develop an improvement in green strength for such mats.

### BRIEF SUMMARY

This disclosure provides a unitary mat including a plurality of lignocellulosic particles, and an adhesive chosen from an isocyanate, phenol formaldehyde, polyamino amido epichlorohydrin, and combinations thereof and present in an amount of from about 1 to about 10 percent by weight based on 100 parts by weight of dry lignocellulosic particles. The unitary mat also includes a proteinaceous powder having a protein dispersibility index of from about 1 to about 90 and present in an amount of from about 0.5 to about 10 percent by weight based on 100 parts by weight of dry lignocellulosic particles, and an aqueous diluent present in an amount of from about 0.5 to about 10 percent by weight based on 100 parts by weight of dry lignocellulosic particles.

This disclosure also provides a continuous process for forming a unitary mat on a line having at least two conveyors spaced from each other. The process includes the steps of combining the adhesive, the proteinaceous powder, the diluent and the plurality of lignocellulosic particles to form a mixture, forming the unitary mat from the mixture on a first conveyer, and transferring the unitary mat from the first conveyor to a second conveyor across a distance while maintaining structural integrity of the unitary mat.

### BRIEF DESCRIPTION OF THE DRAWINGS

The present invention will hereinafter be described in conjunction with the following drawing figures, wherein like numerals denote like elements, and

FIG. 1 is a bar-graph of selected results set forth in the Examples showing tack of various cold-pressed mats;

FIG. 2 is a line-graph of selected results set forth in the Examples showing tack of cold-pressed mats as a function of % aqueous diluent used; and

FIG. 3. is a line-graph of selected results set forth in the Examples showing tack of cold-pressed mats as a function of % SMBS used.

### DETAILED DESCRIPTION

The following detailed description is merely exemplary in nature and is not intended to limit this disclosure. Furthermore, there is no intention to be bound by any theory presented in the preceding background or the following detailed description.

Embodiments of the present disclosure are generally directed to unitary mats and methods for fabricating the same. For the sake of brevity, conventional techniques may not be described in detail herein. Moreover, the various tasks and process steps described herein may be incorporated into a more comprehensive procedure or process having additional steps or functionality not described in detail herein. In particular, various manufacturing processes are well-known and so, in the interest of brevity, many conventional steps will only be mentioned briefly herein or will be omitted entirely without providing the well-known process details.

This disclosure provides a mat and a continuous process for forming the mat. The mat may be described as a unitary mat. The terminology unitary may describe that the mat is a single cohesive piece. Alternatively, the mat may be described as one-piece, unbroken, complete, intact, undivided, integral, undamaged, etc. In other embodiments, the mat is described as being formed using the process such that the mat does not break into pieces or break apart during the process. Alternatively, the mat may be described as maintaining structural integrity throughout the process. The terminology “structural integrity” typically describes the mat as having the strength so as not to break up, break into pieces, or crack, as understood by one of skill in the art.

The mat has a length and a width. The mat also has a thickness. Typically the mat has an undetermined, continuous, unbroken length when formed in the continuous process. However, the mat is eventually cut into a predetermined final size, e.g. after pressing. Typically, the mat has a width of from about 4 to about 12, about 5 to about 11, about 6 to about 10, about 7 to about 9, about 5 to about 10, or about 6 to about 8, feet. The mat typically has a thickness of from about 0.1 to about 6, about 0.2 to about 4, about 0.25 to about 1, about 0.2 to about 0.9, about 0.3 to about 0.8, about 0.4 to about 0.7, or about 0.5 to about 0.6, inches. The mat can have a consistent width and/or thickness across an entirety or only a part of the length. Similarly, the mat can have a consistent length and/or thickness across an entirety or only a part of the width. The mat can be symmetrical or asymmetrical and can be any shape including, but not limited to, square, rectangular, round, etc. All values and ranges of values between and including those described above may also be utilized in various non-limiting embodiments.

The mat is not particularly limited and can be used in various applications. Examples of such applications include, but are not limited to, for packaging; for furniture and cabinetry; for roof and floor sheathing; for roof, floor, and siding paneling; for window and door frames; and for webstock, e.g. webstock for engineered I-beams.

The mat, in various embodiments, can be referred to as various forms of engineered lignocellulosic composites, e.g. as engineered wood composites, such as oriented strand board (OSB); oriented strand lumber (OSL); scrimber; fiberboard, such as low density fiberboard (LDF), medium density fiberboard (MDF), and high density fiberboard (HDF); chipboard; flakeboard or flake board; particleboard (PB); plywood; etc. Generally, the mat is in the form OSB, OSL, PB, scrimber, plywood, LDF, MDF, or HDF, more typically in the form of PB, MDF, HDF, or OSB. However, it is to be appreciated that the mat may be in other engineered wood forms, such as, but not limited to, those described and exemplified herein. It is to be appreciated that the names of lignocellulosic composite articles are often used interchangeably in the art. For example, one may refer to a composite as OSB whereas another may refer to the same composite as flake board.

The mat may be of various sizes, shapes, and thickness. For example, the mat can be configured to mimic conventional composite mats, such as OSB, PB, scrimber, and MDF beams, boards, or panels. The mat can also be of various complex shapes, such as moldings, fascias, furniture, etc. In certain embodiments, the mat is fiberboard, e.g. MDF. In other embodiments, the mat is OSB, scrimber, or OSL. In yet other embodiments, the mat is PB. The mat can include one or more layers. For example, if the mat is OSB, the mat can include one layer, e.g. a core layer, two layers, e.g. a core layer and a face/fascia layer, or three or more layers, e.g. a core layer and two fascia layers.

In certain embodiments, such as for OSB applications, the mat has a first fascia layer including a first portion of the plurality of lignocellulosic particles compressed together and substantially oriented in a first direction. The mat further can have a second fascia layer spaced from and parallel to the first fascia layer and including a second portion of the plurality of lignocellulosic particles compressed together and substantially oriented in the first direction. The mat yet further can have a core layer disposed between the first and second fascia layers and including a remaining portion of the plurality of lignocellulosic particles compressed together and substantially oriented in a second direction different than the first direction. The layers can each include different adhesive systems, depending on the specific components utilized in the respective adhesive systems of the layers. In certain embodiments, at least one of the layers, e.g. one or both of the fascia layers, can include PF resin. Each of the layers can be of various thicknesses, such as those encountered with conventional OSB layers. OSL typically has a plurality of lignocellulosic particles substantially orientated in only one direction. Other types of composite mats, e.g. wood composites, and their processes of manufacture, that can be formed, e.g. by utilizing the adhesive system, are described by pages 395 through 408 of The Polyurethanes Handbook (David Randall & Steve Lee eds., John Wiley & Sons, Ltd. 2002), which is incorporated herein by reference in its entirety in one or more non-limiting embodiments.

The mat has an original thickness, i.e., a thickness after manufacture, e.g. after pressing the mat to form the final mat. The thickness can vary, but is typically of from about 0.25 to about 10, about 0.25 to about 5, or about 0.25 to about 1.5, inches, or any subrange in between. It is to be appreciated that describing thicknesses may not be suitable when describing complex shapes other than boards or panels. As such, the mat can be of various dimensions based on final configuration of the mat. Moreover, in additional non-limiting embodiments, all values and ranges of values including and between those set forth above are hereby expressly contemplated for use.

The mat has an internal bond (IB) strength. The IB strength can be greater than about 20, greater than about 30, greater than about 40, greater than about 50, greater than about 60, greater than about 70, greater than about 80, greater than about 90, or greater than about 100, pounds per square inch (psi), according to ASTM D1037. In certain embodiments, the mat has an IB strength of from about 50 to about 500, about 100 to about 300, or about 150 to about 250, psi, according to ASTM D1037, or any subrange in between. All values and ranges of values between and including those described above may also be utilized in various non-limiting embodiments.

IB strength is a tensile property. Typically, in conventional mats, as IB strength increases, flexural properties such as modulus of elasticity (MOE) and modulus of rupture (MOR) change, specifically, MOE generally decreases as IB strength increases. In various embodiments, the mat has a MOE greater than about 75,000, greater than about 95,000, greater than about 100,000, or greater than about 110,000, psi, according to ASTM D1037. Typically, the mat has a MOR greater than about 3,000, greater than about 3,250, greater than about 3,300, or greater than about 3,500, psi, according to ASTM D1037. All values and ranges of values between and including those described above may also be utilized in various non-limiting embodiments.

The mat includes a plurality of lignocellulosic particles and an adhesive chosen from an isocyanate, phenol formaldehyde, polyamino amido epichlorohydrin, and combinations thereof and present (or utilized) in an amount of from about 1 to about 10 percent by weight based on 100 parts by weight of dry lignocellulosic particles. The mat also includes a proteinaceous powder having a protein dispersibility index of from about 1 to about 90 and present (or utilized) in an amount of from about 0.5 to about 10 percent by weight based on 100 parts by weight of dry lignocellulosic particles, and an aqueous diluent present (or utilized) in an amount of from about 0.5 to about 10 percent by weight based on 100 parts by weight of dry lignocellulosic particles. It is also contemplated that the mat may be, consist essentially of, or consist of, the plurality of lignocellulosic particles, the adhesive, the proteinaceous powder, and the aqueous diluent. In various embodiments, the mat may be free of, or include less than about: 1, 0.5, 0.1, or 0.05, weight percent of one or more of the optional additives described below, based on a total weight of the mat. In one embodiment, the mat is free of polymeric 4,4′□methylene diphenyl isocyanate. In another embodiment, the mat is free of phenol formaldehyde. In still another embodiment, the mat is free of polyamino amido epichlorohydrin. In another embodiment, the mat is free of one or more of the proteinaceous powders described below so long as the mat includes at least one such powder. In other embodiments, the mat is free of one or more of the aqueous diluents described below so long as the mat includes at least one such aqueous diluent. Each of the aforementioned components is described in greater detail below. Moreover, in additional non-limiting embodiments, all values and ranges of values including and between those set forth above are hereby expressly contemplated for use.

### Plurality of Lignocellulosic Particles:

The mat includes the plurality of lignocellulosic particles. The plurality of lignocellulosic particles may be alternatively described as lignocellulosic material or lignocellulosic pieces. The lignocellulosic material may be alternatively described as a plurality of lignocellulosic pieces. The plurality of lignocellulosic particles can be derived from a variety of lignocellulosic materials. Generally, the plurality of lignocellulosic particles is derived from wood; however, the plurality of lignocellulosic particles can be derived from other lignocellulosic materials, such as from bagasse, straw, flax residue, nut shells, cereal grain hulls, etc., and mixtures thereof. If wood is utilized as the lignocellulosic material, the plurality of lignocellulosic particles can be prepared from various species of hardwoods and/or softwoods. Non-lignocellulosic materials in flake, fibrous or other particulate form, such as glass fiber, mica, asbestos, rubber, plastics, etc., can also be mixed with plurality of lignocellulosic particles. However, such materials are not required.

The plurality of lignocellulosic particles can come from a variety of processes, such as by comminuting small logs, industrial wood residue, branches, rough pulpwood, etc. into pieces in the form of sawdust, chips, flakes, wafer, strands, scrim, fibers, sheets, etc. In certain embodiments, the plurality of lignocellulosic particles includes those pieces typically utilized for forming OSB, OSL, scrimber, and particleboards (PB). In other embodiments, the plurality of lignocellulosic particles includes those pieces typically utilized for forming fiberboards, such as LDF, MDF, and HDF. In yet another embodiment, the plurality of lignocellulosic particles includes those pieces typically utilized for forming plywood. It is to be appreciated that the mat can include various combinations of the aforementioned materials and/or pieces, such as strands and sawdust. In addition, the mat may be formed into shapes other than panels and boards.

The plurality of lignocellulosic particles can be produced by various conventional techniques. For example, pulpwood grade logs can be converted into flakes in one operation with a conventional roundwood flaker. Alternatively, logs and logging residue can be cut into fingerlings on the order of from about 0.5 to about 3.5 inches long with a conventional apparatus, and the fingerlings flaked in a conventional ring type flaker. The logs are typically debarked before flaking. The mat is not limited to any particular process of forming the plurality of lignocellulosic particles.

The dimensions of the plurality of lignocellulosic particles are not particularly critical. In certain embodiments, such as those used to form OSB, the plurality of lignocellulosic particles typically includes strands having an average length of from about 2.5 to about 6 inches, an average width of from about 0.5 to about 2 inches, and an average thickness of from about 0.1 to about 0.5 inches. It is to be appreciated that other sizes can also be utilized, as desired by one skilled in the art. In some of these embodiments, the mat may include other types of lignocellulosic particles, such as chips, in addition to the strands. In certain embodiments, strands which are typically about 1.5 inches wide and about 12 inches long can be used to make laminated strand lumber, while strands typically about 0.12 inches wide and about 9.8 inches long can be used to make parallel strand lumber. In certain embodiments, such as those used to form flakeboard, the plurality of lignocellulosic particles includes flakes having an average length of from about 2 to about 6 inches, an average width of about 0.25 to about 3 inches, and an average thickness of from about 0.005 to about 0.05 inches. In other embodiments, such as those used to from scrimber, the plurality of lignocellulosic particles includes thin, irregular pieces having average diameters ranging from about 0.25 to about 20, about 0.5 to about 15, or about 1 to about 10, mm, and lengths ranging from several inches to several feet in length. Detailed information on suitable sizes and shapes of the plurality of lignocellulosic particles, e.g., scrim, as well as processes of manufacturing scrimber, is described in U.S. Pat. No. 6,344,165 to Coleman, the disclosure of which is incorporated herein by reference in its entirety in a non-limiting embodiment. In yet other embodiments, the plurality of lignocellulosic particles are those typically used to form conventional PB. The plurality of lignocellulosic particles can be further milled prior to use, if such is desired to produce a size more suitable for producing a desired mat. For example, hammer, wing beater, and toothed disk mills may be used for forming the plurality of lignocellulosic particles of various sizes and shapes. Moreover, in additional non-limiting embodiments, all values and ranges of values including and between those set forth above are hereby expressly contemplated for use.

The plurality of lignocellulosic particles has a moisture content and may or may not be dry (i.e., have a moisture content of less than about 0.5 weight percent). The plurality of lignocellulosic particles typically has a moisture content of about 0.5 to about 30 weight percent of water, based on 100 parts by weight of the plurality of lignocellulosic particles. In various other embodiments, the plurality of lignocellulosic particles has a moisture content of from about 0.5 to about 25, about 0.5 to about 20, about 0.5 to about 15, about 0.5 to about 10, about 0.5 to about 5, about 1 to about 25, about 1 to about 20, about 1 to about 15, about 1 to about 10, about 1 to about 5, about 2 to about 15, about 3 to about 12, or about 5 to about 10, weight percent of water, based on 100 parts by weight of the plurality of lignocellulosic particles. The water can assist in the curing or setting of the mat. The moisture of the plurality of lignocellulosic particles is typically inherent in that independent or external water is typically not added. All values and ranges of values between and including those described above may also be utilized in various non-limiting embodiments. The plurality of lignocellulosic particles may be dried before use. Alternatively, water may be added to the plurality of lignocellulosic particles before use.

The plurality of lignocellulosic particles is utilized in the mat in various amounts, depending on the type of mat desired to be formed. Typically, such as in OSB, PB, scrimber, or MDF applications, the plurality of lignocellulosic particles is utilized in an amount of from about 75 to about 99, about 85 to about 98, about 90 to about 97, or about 92 to about 95.5, parts by weight, based on 100 parts by weight of the mat, or any subrange in between. It is to be appreciated that the amounts can be higher or lower depending on various factors, including moisture content of the plurality of lignocellulosic particles. For example, moisture content of the plurality of lignocellulosic particles can vary by geographic location, source, etc., such as variations from mill to mill. Moreover, in additional non-limiting embodiments, all values and ranges of values including and between those set forth above are hereby expressly contemplated for use.

Adhesive

The mat also includes an adhesive chosen from an isocyanate, phenol formaldehyde, polyamino amido epichlorohydrin, and combinations thereof. In one embodiment, the isocyanate is polymeric 4,4′-methylene diphenyl. In another embodiment, the adhesive is the phenol formaldehyde. In a further embodiment, the adhesive is the polyamino amido epichlorohydrin. Moreover, combinations of two or more of the adhesive may be used, as described above or below. In various embodiments, the terminology “isocyanate” may be substituted for “isocyanate component,” which may include a reaction product of an isocyanate once the mat is formed or upon compression and eventual forming of a board.

In various embodiments, the isocyanate is a polyisocyanate having two or more functional groups, e.g. two or more isocyanate (NCO) groups. Said another way, the isocyanate can just be an isocyanate or a combination of isocyanates. Suitable organic polyisocyanates include, but are not limited to, conventional aliphatic, cycloaliphatic, araliphatic and aromatic isocyanates. In certain embodiments, the isocyanate is selected from the group of diphenylmethane diisocyanates (MDIs), polymeric diphenylmethane diisocyanates (pMDIs), and combinations thereof. Polymeric diphenylmethane diisocyanates can also be called polymethylene polyphenylene polyisocyanates. In other embodiments, the isocyanate is an emulsifiable MDI (eMDI). Examples of other suitable isocyanates include, but are not limited to, toluene diisocyanates (TDIs), hexamethylene diisocyanates (HDIs), isophorone diisocyanates (IPDIs), naphthalene diisocyanates (NDIs), and combinations thereof. In a specific embodiment, the isocyanate is MDI. In another specific embodiment, the isocyanate is pMDI, i.e., polymeric methylene-4,4′-diphenyl diisocyanate. In further specific embodiments, the isocyanate is a combination of MDI and pMDI. It is to be appreciated that all isomers of MDI are contemplated herein including but not limited to 4,4′-MDI, and 2,4′-MDI.

In certain embodiments, the isocyanate is an isocyanate-terminated prepolymer. The isocyanate-terminated prepolymer is a reaction product of an isocyanate and a polyol and/or a polyamine. The isocyanate may be any type of isocyanate in the polyurethane art, such as one of the polyisocyanates. If utilized to make the isocyanate-terminated prepolymer, the polyol is typically selected from the group of ethylene glycol, diethylene glycol, propylene glycol, dipropylene glycol, butane diol, glycerol, trimethylolpropane, triethanolamine, pentaerythritol, sorbitol, and combinations thereof. The polyol may also be a polyol as described and exemplified further below with discussion of the isocyanate-reactive component. If utilized to make the isocyanate-terminated prepolymer, the polyamine is typically selected from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof. The isocyanate-terminated prepolymer may be formed from a combination of two or more of the aforementioned polyols and/or polyamines.

In still other embodiments, the isocyanate is further defined as a pure liquid or solid (wherein the terminology “pure” is as appreciated in the isocyanate arts), as an isocyanate prepolymer (NCO terminated and/or hydroxyl terminated), an allophanate-isocyanate, a biuret-isocyanate, an isocyanate-isocyanate, a carbodiimide-isocyanurate, a polyurethane-isocyanate hybrid, a polyurea-isocyanate hybrid, and/or combinations thereof. In one embodiment, the isocyanate has a number average molecular weight of from about 255 to about 280 g/mol, a weight average molecular weight of from about 470 to about 550 g/mol, a viscosity of from about 170 to about 200 cP measured at 25° C., and a surface tension of about 41 to about 46 mN/m measured at 25° C. Moreover, in additional non-limiting embodiments, all values and ranges of values including and between those set forth above are hereby expressly contemplated for use.

Alternatively, the isocyanate may be present (or utilized) in an organic emulsion. For example, the isocyanate may be present (or utilized) in as a dispersed phase in an emulsion having about 50 to about 99, about 50 to about 95, about 55 to about 90, about 60 to about 85, about 65 to about 80, or about 70 to about 80, or about 75, weight percent of a continuous phase.

In still other embodiments, the isocyanate has a percent NCO of from about 0 to about 33, from about 5 to about 30, from about 10 to about 25, or from about 15 to about 20. In additional embodiments, any value, or range of values, both whole and fractional, within or between any one or more values described above are contemplated.

The isocyanate typically has a viscosity which is suitable for specific applications of the isocyanate to the plurality of lignocellulosic particles, such as by spraying, fogging and/or atomizing the isocyanate to apply the isocyanate to the plurality of lignocellulosic particles. Typically, the isocyanate has a viscosity of from about 100 to about 5,000, about 100 to about 2,500, or about 100 to about 1,000, cps at 25° C. according to ASTM D2196, or any subrange in between. Moreover, in additional non-limiting embodiments, all values and ranges of values including and between those set forth above are hereby expressly contemplated for use.

The adhesive is present (or utilized) in the mat in an amount of from about 1 to about 10 percent by weight based on 100 parts by weight of dry lignocellulosic particles. In various embodiments, the adhesive is present (or utilized) in an amount of from about 1.5 to about 9.5, about 2 to about 9, about 2.5 to about 8.5, about 3 to about 8, about 3.5 to about 7.5, about 4 to about 7, about 4.5 to about 6.5, about 5 to about 6, or about 5.5. to about 6, percent by weight based on 100 parts by weight of dry lignocellulosic particles. Moreover, in additional non-limiting embodiments, all values and ranges of values including and between those set forth above are hereby expressly contemplated for use. In various non-limiting embodiments, the adhesive includes one or more components as described in U.S. Pat. Nos. 8,895,643 and/or 9,771,460, each of which is expressly incorporated herein by reference in these non-limiting embodiments.

### Proteinaceous Powder

The mat also includes a proteinaceous powder having a protein dispersibility index of from about 1 to about 90. In various embodiments, the protein dispersibility index is from about 5 to about 90, from about 10 to about 90, from about 15 to about 90, from about 5 to about 15, from about 5 to about 10, from about 1 to about 5, from about 1 to about 10, from about 1 to about 15, from about 1 to about 20, from about 20 to about 90, 25 to about 85, about 30 to about 80, about 35 to about 75, about 40 to about 70, about 45 to about 65, about 50 to about 60, or about 55 to about 60. In other embodiments, the protein dispersibility index is from about 70 to about 90, about 75 to about 85, about 80 to about 85, greater than about 70, greater than about 75, greater than about 80, greater than about 85, or greater than about 90. Moreover, in additional non-limiting embodiments, all values and ranges of values including and between those set forth above are hereby expressly contemplated for use.

The Protein Dispersibility Index (PDI) is a means of comparing the solubility of a protein in water. In other words, the PDI is a measure of how much protein is available to be solubilized in water. The PDI can be important because higher values indicate that more of the protein in the proteinaceous powder can be solubilized, e.g. by the aqueous diluent, and contribute to the green strength/tack of the mat that is formed.

The proteinaceous powder is not particularly limited and may be any known in the art. In various embodiments, the proteinaceous powder is chosen from soy flour, soy concentrate, soy isolate, canola flour, wheat flour, cottonseed flour, peanut flour, corn flour, pea flour, almond flour, buckwheat flour, and combinations thereof. In other embodiments, the proteinaceous powder is soy flour. The proteinaceous powder is typically present (or utilized) in an amount of from about 0.5 to about 10 percent by weight based on 100 parts by weight of dry lignocellulosic particles. In various embodiments, the proteinaceous powder is present (or utilized) in an amount of from about 0.5 to about 9.5, about 1 to about 9.5, about 1.5 to about 9.5, about 2 to about 9, about 2.5 to about 8.5, about 3 to about 8, about 3.5 to about 7.5, about 4 to about 7, about 4.5 to about 6.5, about 5 to about 6, about 5.5. to about 6, about 1.5 to about 3.5, about 2 to about 3, about 2 to about 2.5, or about 2.5 to about 3, percent by weight based on 100 parts by weight of dry lignocellulosic particles. Moreover, in additional non-limiting embodiments, all values and ranges of values including and between those set forth above are hereby expressly contemplated for use.

### Aqueous Diluent

The mat also includes an aqueous diluent. The aqueous diluent is not particularly limited and may be any known in the art. In various embodiments, the aqueous diluent is chosen from glycerol, glycerol derivatives, monomeric- and polymeric ethylene glycol, monomeric and polymeric propylene glycol, sorbitol, sucrose, high fructose corn syrup, urea, thiourea, guanidine hydrochloride, sodium dodecyl sulfate, 2-methoxyethanol, ethylene carbonate, propylene carbonate, methyl pyrrolidone, lactose, maltodextrin, cyclodextrin. In one embodiment, the aqueous diluent is glycerol. In another embodiment, the aqueous diluent is urea. In still another embodiment, the aqueous diluent includes a combination of glycerol and urea.

The aqueous diluent is present (or utilized) in an amount of from about 0.5 to about 10 percent by weight based on 100 parts by weight of dry lignocellulosic particles. In various embodiments, the aqueous diluent is present (or utilized) in an amount of from about 0.5 to about 9.5, about 1 to about 9.5, about 1.5 to about 9.5, about 2 to about 9, about 2.5 to about 8.5, about 3 to about 8, about 3.5 to about 7.5, about 4 to about 7, about 4.5 to about 6.5, about 5 to about 6, about 5.5. to about 6, about 1.5 to about 3.5, about 2 to about 3, about 2 to about 2.5, or about 2.5 to about 3, percent by weight based on 100 parts by weight of dry lignocellulosic particles. Moreover, in additional non-limiting embodiments, all values and ranges of values including and between those set forth above are hereby expressly contemplated for use.

In various embodiments, the mat includes, or is free of, one or more additives. These additive may include sodium metabisulfite (SMBS), release agents, fatty acids, waxes, silicones, soaps, detergents, catalysts, etc. In other embodiments, the mat includes from 0.005 to 0.050, from 0.010 to 0.040, from 0.015 to 0.035, from 0.020 to 0.030, from 0.020 to 0.025, or from 0.025 to 0.030, percent by weight based on 100 parts by weight of dry lignocellulosic particles. Moreover, in additional non-limiting embodiments, all values and ranges of values including and between those set forth above are hereby expressly contemplated for use.

In various embodiments, the mat is free of, or includes less than about: 5, 4, 3, 2, 1, 0.5, or 0.1, weight percent of, a self-polymerization product of an isocyanate formed in-situ, a formaldehyde resin, a methylolated urea, or oligomers formed therefrom, UF glue or binders, and/or a tackifying compound and/or adhesive, different from the adhesive/proteinaceous powder/aqueous diluent of this disclosure, based on 100 parts by weight of the mixture as a whole. In certain embodiments, the mat is substantially free of UF resin and/or PF resin. By “substantially free”, it is meant that in these embodiments, the UF resin and/or PF resin is present (or utilized) in an amount no greater than about 15, no greater than about 10, no greater than about 5, or approaching or equaling 0, parts by weight, based on 100 parts by weight of the article, or any subrange in between. In other embodiments, the article is completely free of UF resin and/or PF resin. The mat may include an amount of water of less than about: 10, 5, 4, 3, 2, 1, 0.5, or 0.1, weight percent, based on 100 parts by weight of the mat. Moreover, in additional non-limiting embodiments, all values and ranges of values including and between those set forth above are hereby expressly contemplated for use.

In various embodiments, the mat is tested for tack or green strength using a “tack test.” In this test, the plurality of lignocellulosic particles are dried to from about 1.0 and about 8.0% moisture content prior to use. These particles are then placed in a shear blender and the proteinaceous powder is added at a level from about 0.5 and about 10.0% on a dry powder/dry lignocellulosic particle basis. The adhesive is applied to the particles including the proteinaceous powder by spraying at a level from about 1.0 and about 10.0% dry adhesive to dry powder/dry lignocellulosic particle basis. The aqueous diluent, e.g. at a concentration from about 1 to about 100%, from about 15 to about 85%, or from about 30 to about 70%, is then applied to the mixture. The blended material is formed into a mat measuring about 10″×about 10″ such that the mass of material when pressed to 0.75″ would yield a panel of density about 40 to about 50 lb/ft³. The mat is pressed at room temperature for about 1 min at a pressure of about 100 psi inside a form to prevent excessive spreading of the mat and thereby producing a consolidated mat measuring about 10″×about 10″ with a thickness from about 1.5 to about 2.5″. The mat is then transferred to a small table upon a moveable belt. The mat is lined up to the edge of the table prior to starting the test. The mat is then pulled by the belt so that the mat hangs over the edge of the table until the hanging mat breaks off The tack or green strength is quantified as the distance, in inches or centimeters, that hanged over the edge of the table before the mat broke off. The greater the distance, the higher the inherent tack of the system. In various embodiments, the mat has a tack or green strength of from about 1 to about 4, from about 2 to about 4, from about 3 to about 4, from about 1 to about 3, from about 2 to about 3, from about 1 to about 2, greater than about 2, greater than about 2.5, greater than about 3, greater than about 3.5, or greater than about 4, inches, as determined using the aforementioned test. Moreover, in additional non-limiting embodiments, all values and ranges of values including and between those set forth above are hereby expressly contemplated for use.

### Process for Forming the Mat

This disclosure also provides a process for forming the mat. The process may be a batch or continuous process. Typically, the process is a continuous process. In one embodiment, the process is further defined as a continuous process for forming the mat on a line having at least two conveyors, e.g. a first conveyor and a second conveyor. The line and the two conveyors can be any known in the art of forming mats including the plurality of lignocellulosic particles. For example, the line and the conveyors may be those used to form UF, PF, and/or MUPF particleboards, as would be understood to those of skill in the art. The two conveyors are spaced from one another with a distance in between. This distance may be described as a distance or a predefined or predetermined space or distance. This distance may be from about 1 to about 20 cm or from about 5 to about 20 cm. In various embodiments, this distance is about: 1, 2, 3, 4, 5, 6, 7, 8, 9, 10, 11, 12, 13, 14, 15, 16, 17, 18, 19, or 20, cm, or any value or range of values therebetween. The two conveyors can be further defined as a first conveyor and a second conveyor. However, this disclosure it not limited to use of only two conveyors. More than one first conveyor can be utilized, e.g. a set of first conveyors. Similarly, more than one second conveyor can be utilized, e.g. a set of second conveyors. Alternatively, three, four, five, or more conveyors can be utilized. The orientation and operation of these conveyors may be the same as those traditionally understood by those of skill in the art, as described above.

The process typically includes the step of combining the plurality of lignocellulosic particles, the proteinaceous powder, the adhesive, and the aqueous diluent to form a mixture. However, any one or more of the proteinaceous powder, the adhesive, and/or the aqueous diluent may be combined with one another in any step of the process in whole or in part. All orders of addition are hereby expressly contemplated. For example, the plurality of lignocellulosic particles, the proteinaceous powder, the adhesive, and the aqueous diluent may be combined in any amounts and any order to form the mixture. In various embodiments, the plurality of lignocellulosic particles and the proteinaceous powder are first combined in a blender. Then, the aqueous diluent is added and then the adhesive. Additional orders of addition are set forth in the Examples.

Similarly, the plurality of lignocellulosic particles, the proteinaceous powder, the adhesive, and the aqueous diluent may be combined at any temperature to form the mixture. The step of combining may occur below, at, or above room temperature (e.g. 25° C.). In various embodiments, the step of combining occurs at a temperature of from about 36 to about 120, about 40 to about 115, about 45 to about 110, about 50 to about 105, about 55 to about 100, about 60 to about 95, about 65 to about 90, about 70 to about 85, or about 75 to about 80, ° F. Moreover, in additional non-limiting embodiments, all values and ranges of values including and between those set forth above are hereby expressly contemplated for use.

The step of forming the mixture may include combining the proteinaceous powder, the adhesive, and/or the aqueous diluent with the plurality of lignocellulosic particles at the same time or at different times. One or more of the proteinaceous powder, the adhesive, and/or the aqueous diluent can be applied to the plurality of lignocellulosic particles by various processes, such as by mixing, tumbling, rolling, spraying, sheeting, blow-line resination, blending (e.g. blow-line blending), etc. For example, one or more of the proteinaceous powder, the adhesive, and/or the aqueous diluent and the plurality of lignocellulosic particles can be mixed or milled together during the formation of the mixture, also referred to as a “furnish”, as further described below.

In various embodiments, one or more of the proteinaceous powder, the adhesive, and/or the aqueous diluent is applied to the plurality of lignocellulosic particles by a spraying, an atomizing or a fogging process. The plurality of lignocellulosic particles including the proteinaceous powder, the adhesive, and/or the aqueous diluent can then be disposed on a carrier, and generally form (or define) the mixture or the mat. The mixture can then be formed into mat, such as by dropping the mixture onto a carrier, e.g. a conveyor belt, or, alternatively, the mat can be formed directly on the carrier. In other words, the plurality of lignocellulosic particles and the proteinaceous powder, the adhesive, and/or the aqueous diluent can be arranged on the carrier to form the mixture in various ways. The mixture can then be fed to a former, which generally forms the mixture into a mat having a predetermined width and a predetermined thickness with the plurality of lignocellulosic particles loosely oriented on the carrier. The predetermined width and thickness of the mat can be determined according to final widths and thicknesses desired for the article, as described further below. The mat can then be formed in various shapes, such as boards or panels, or formed into more complex shapes such as by molding or extruding.

In certain embodiments, one or more of the proteinaceous powder, the adhesive, and/or the aqueous diluent is sprayed, atomized, and/or fogged onto the plurality of lignocellulosic particles while the plurality of lignocellulosic particles is agitated in suitable equipment. Spraying, atomizing and fogging can occur via use of nozzles, such as one nozzle for each individual component supplied thereto, or nozzles that have two or more of the proteinaceous powder, the adhesive, and/or the aqueous diluent premixed and supplied thereto. To maximize coverage of the plurality of lignocellulosic particles, the proteinaceous powder, the adhesive, and/or the aqueous diluent can be generally applied by spraying droplets or atomizing or fogging onto the plurality of lignocellulosic particles as the plurality of lignocellulosic particles is being tumbled in a rotary blender or similar apparatus. As another example, the plurality of lignocellulosic particles can be coated with the one or more of the proteinaceous powder, the adhesive, and/or the aqueous diluent in a rotary drum blender equipped with at least one, typically at least two or three spinning disk atomizers. Tumblers, drums, or rollers including baffles can also be used. Shear force can be useful.

The amount of the proteinaceous powder, the adhesive, and/or the aqueous diluent to be applied and mixed with the plurality of lignocellulosic particles can be dependent upon several variables including, moisture content and type of the plurality of lignocellulosic particles used, the intended use of the mat, and the desired properties of the mat. The resulting mixture is typically formed into a single or multi-layered mat that is compressed into, for example, OSB, PB, scrimber, MDF, or another mat of the desired shape and dimensions. The mixture can also be formed into more complex shapes, such as by molding or extruding the mixture.

The process also includes the step of forming the mat from the mixture. The step of forming is not particularly limited and may include pressing under any amount of heat and/or pressure. Both hot-press and cold-press processes are contemplated for use herein. For example, a continuous conveyor system may be used. In one embodiment, a continuously driven conveyor is passed beneath a dispersing device that disperses the mixture onto the conveyor. An endless mat may be formed on the conveyor by the dispersing device. The endless mat may be divided or cut using a saw or other cutting device. The continuous conveyor may include multiple independent conveyor belts upon which the mat is formed and/or travels. The tack test values described in this disclosure are indicative of the green strength/tack that maximizes the continuity of the mat as it travels between independent conveyor belts and minimize a chance of breaking or failing.

In one embodiment, after the mixture is removed from the blender, the mixture is placed onto a conveyor and then pre-pressed to form an initial mat that is different from the final mat formed in this disclosure. The initial mat is then passed along one or more conveyor belts and is finally pressed in a heated press, e.g. at a temperature of from about 325 to about 375, from about 325 to about 350, or from about 350 to about 375, ° F.

The mat can be formed in any suitable manner. For example, the mixture can be deposited on a plate-like carriage carried on an endless belt or conveyor from one or more hoppers spaced above the belt. When a multi-layer mat is formed, a plurality of hoppers can be used with each having a dispensing or forming head extending across the width of the carriage for successively depositing a separate layer of the mixture as the carriage is moved between the forming heads. The mat thickness will vary depending upon such factors as the size and shape of the plurality of lignocellulosic particles, the particular technique used in forming the mat, the desired thickness and density of the final mat and the pressure used during the press cycle. The thickness of the mat is usually about 5 times to about 20 times a final thickness of the mat. For example, for flakeboard or matboard panels of about 0.5 inch thickness and a final density of about 35 lbs/ft³, the mat usually will originally be about 3 inches to about 6 inches thick.

Typically, the plurality of lignocellulosic particles is loosely oriented in the mixture and mat. A carrier is typically provided, such as a conveyor belt or plate, and the mixture and eventual mat is disposed on the carrier. The mixture can either be formed directly on the carrier, and/or transferred to the carrier, after forming, e.g. in a tumbler. In one embodiment, the proteinaceous powder, the adhesive, and/or the aqueous diluent substantially maintains orientation of the plurality of lignocellulosic particles in the mixture while on the carrier. There is no requirement that the orientation is maintained perfectly. For example, minor distortion may occur. In general, the proteinaceous powder, the adhesive, and the aqueous diluent typically serves as a “tackifier” or as “sticky” glue, and can be used as a substitute for, or in addition to, adhesives/resins such as isocyanates, UF resins and/or PF resins, as well as for other conventional adhesives. As such, the mixture can be said to have tack or cold-tack.

In addition to the tack test values described above, cold-tack can be determined in a variety of ways. For example, one can use a “slump” test, which employs a funnel packed full of the mixture, the funnel is then tipped onto a surface and removed, such that the mixture (in the shape of the funnel) remains on the surface. The funnel shaped mixture can then be observed for changes in shape over time, such as changes in angle due to slumping/collapsing of the funnel shaped mixture. Another example is referred to as a “snowball” test, where one can grab a handful of the mixture, make a ball of the mixture in hand, and toss the ball up and down to determine if the ball falls apart. Other suitable tests are described in ASTM D1037.

When the mixture is formed into the mat, the mixture typically substantially maintains the width and the thickness of the mat while the mat is on the carrier. As can be appreciated, when the carrier moves, such as by conveying, the mixture keeps the mat from falling apart due to vibrations. Vibrations can also occur, for example, if the carrier is a plate, and the plate is being moved to a press. Such vibrations can cause orientation problems with the lignocellulosic pieces, can cause reduced modulus of rupture/elasticity (MOR/E) and/or internal bond (IB) strength, and can cause other similar issues.

The mat is typically formed from the mixture by compressing the mixture at a temperature, which may or may not be elevated, and under pressure, which may be higher than atmospheric pressure. Typically, at least pressure is applied to the mat for an amount of time sufficient to form the mat. Heat may or may not be applied. By imparting tack, the mixture can reduce movement of the plurality of lignocellulosic particles in the mat, such as by reducing a chance that the plurality of lignocellulosic particles will blow apart when applying pressure to the mat. Specifically, speed of applying pressure to the mixture to form the mat can be increased relative to conventional pressing speed and/or pressures utilized to form conventional mats, which provides economic benefits, such as increased throughput, for manufacturers of the mat. The same tack imparted by the mixture is useful during movement of the mat, such as when being conveyed.

Press temperatures, pressures and times vary widely depending upon the shape, thickness and the desired density of the mat, the size and type of the plurality of lignocellulosic particles, e.g. wood flakes or sawdust, the moisture content of the plurality of lignocellulosic particles, and the specific proteinaceous powder, the adhesive, and/or the aqueous diluent utilized. The press temperature, for example, can range from about room temperature to about 300° C. To minimize generation of internal steam and the reduction of the moisture content of the final mat below a desired level, the press temperature is typically less than about 250° C. and most typically from about 170° C. to about 240° C., or any subrange in between. The pressure utilized is generally from about 300 to about 800 pounds per square inch (psi), or any subrange in between. Typically, the press time is from about 5s/mm to about 45 s/mm, or any subrange in between. The press time utilized should be of sufficient duration to at least substantially cure the mixture and to provide a mat of the desired shape, dimension and strength. For the manufacture of, e.g. flakeboard or PB panels, the press time depends primarily upon the panel thickness of the mat produced. For example, the press time is generally from about 200 seconds to about 300 seconds for a mat with about a 0.5 inch thickness. Moreover, in additional non-limiting embodiments, all values and ranges of values including and between those set forth above are hereby expressly contemplated for use.

Without being bound or limited to any particular theory, it is thought that the use of the proteinaceous powder, the adhesive, and the aqueous diluent can reduce the amount of time required to form the mat relative to the amount of time required when these components are not utilized to form the mat. As such, throughput of the mats can be increased via increased manufacturing speeds, e.g. press speeds (i.e., shorter pressing times). Other manufacturing benefits can also be realized, such as improved application of the proteinaceous powder, the adhesive, and/or the aqueous diluent of the mixture to the plurality of lignocellulosic particles relative to conventional adhesives. In addition, it is believed that the mats include excellent physical properties. For example, in certain embodiments, the mats can have one or more of the following: increased bond strength, reduced edge swelling, improved release properties, improved flexural modulus, and/or reduced emissions, each relative to conventional mats.

The process also typically includes the step of transferring the mat from the first conveyor to the second conveyor across a distance while maintaining the structure integrity of the mat. The process may include two or more steps of transferring across distances which may have dimensions as described above. The distance is typically the distance at which the at least two conveyors are spaced apart from each other. The maintenance of the structural integrity can be as described above wherein the mat does not break apart or break into pieces during as the mat travels over the distance.

In one embodiment, the plurality of lignocellulosic particles is heated in a drier to control the moisture content. The plurality of lignocellulosic particles may then be mixed in a blender with the proteinaceous powder, the adhesive, and/or the aqueous diluent to form a mixture. The temperature of the mixture when exiting the blender may vary. The mixture is then typically transferred to formers, e.g. a core former or the surface layer former.

The formers typically lay the mixture on a first conveyer belt in such a way that when the mat is formed, it is formed with one, two, three, or more layers, typically with three layers. Top and bottom layers are typically described as surface layers while a middle layer is typically described as a core layer. However, additional first conveyors, e.g. a set of first conveyors, may also be used.

The first conveyer typically moves the mixture to a prepress wherein the mixture is compressed to form a composite. The composition is then typically carried by a second conveyor into a heated press wherein the composite is heated to form a mat. However, additional conveyors beyond the second conveyor may also be used. During transfer of composite from the first to the second (or additional) conveyors, the composite encounter transitions and/or gaps. The size of the gaps varies. If the composite does not have sufficient strength, the composite loses structural integrity while passing over the gaps/or transitions. The time it takes to make and move the composite is approximately 15 to 30 minutes.

### Examples

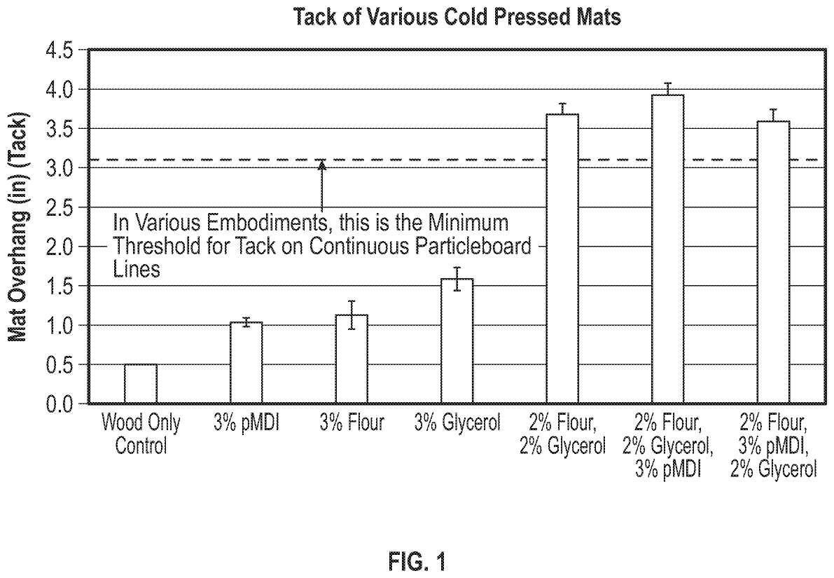

A series of mats are made both according to this disclosure and also as comparative mats. After formation, the mats are evaluated using the tack test described above to determine green strength. The compositions used to form various mats (Samples 1-29) are set forth in Table 1 below. The results of the tack test are set forth in Table 2 below. A first selected summary of the results of Table 2, including approximate rounding of values, is set forth in Table 3 below. A second selected summary of the results of Table 2, focusing on inclusion of glycerol, including approximate rounding of values, is set forth in Table 4 below. A third selected summary of the results of Table 2, focusing on inclusion of urea, including approximate rounding of values, is set forth in Table 5 below. A fourth selected summary of the results of Table 2, focusing on the use of varying amounts of sodium metabisulfite (SMBS), is set forth in Table 6 below. Finally, various results are visually depicted in FIGS. 1-3.

More specifically, the mats are formed using the procedure described above with a 100 psi pre-press load, and a 60 second pre-press time. This is a cold-press process (about 25° C.). Each sample is created using lignocellulosic particles designated as face furnish composed of mixed hardwoods and softwoods obtained from a commercial source in the Pacific Northwest, USA. TS9200 Dry Flour is Prolia 200-90 soy flour and is commercially available from Cargill Inc., Minneapolis, Minn. Glycerol, urea, and SMBS are all obtained from Sigma Aldrich.

TABLE 1

| | | | Face Resination | | | | |
|---|---|---|---|---|---|---|---|
| | | | Resin | Dry | Dry | | |
| | | Furnish | Load | Flour | Urea | Glycerol | Target |
| | | MC | (pph Dry | (pph Dry | (pph Dry | (pph Dry | Mat MC |
| Sample | Components | (%) | Wood) | Wood) | Wood) | Wood) | (%) |
| 1 | No Adhesive | 3.5 | 0.0 | 0.0 | 0.0 | 0.0 | 8.0 |
| | No | | | | | | |
| | Proteinaceous | | | | | | |
| | Powder | | | | | | |
| 2 | 3.0% pMDI | 3.5 | 0.0 | 0.0 | N/A | N/A | 8.0 |
| 3 | TS9200 | 5.4 | 3.0 | 3.0 | N/A | N/A | 8.0 |
| | Dry Flour | | | | | | |
| 4 | 1% Glycerol | 5.4 | 1.0 | 0.0 | 0.0 | 1.0 | 8.0 |
| 5 | 3% Glycerol | 5.4 | 3.0 | 0.0 | 0.0 | 3.0 | 8.0 |
| 6 | 5% Glycerol | 5.4 | 5.0 | 0.0 | 0.0 | 5.0 | 8.0 |
| 7 | TS9200 1% + | 5.4 | 2.0 | 1.0 | 0.0 | 1.0 | 8.0 |
| | 1% Glycerol | | | | | | |
| 8 | TS9200 1% + | 5.4 | 3.0 | 1.0 | 0.0 | 2.0 | 8.0 |
| | 2% Glycerol | | | | | | |
| 9 | TS9200 1% + | 5.4 | 4.0 | 1.0 | 0.0 | 3.0 | 8.0 |
| | 3% Glycerol | | | | | | |
| 10 | TS9200 2% + | 5.4 | 2.5 | 2.0 | 0.0 | 0.5 | 8.0 |
| | 0.5% | | | | | | |
| | Glycerol | | | | | | |
| 11 | TS9200 2% + | 5.4 | 3.0 | 2.0 | 0.0 | 1.0 | 8.0 |
| | 1% Glycerol | | | | | | |
| 12 | TS9200 2% + | 5.4 | 3.5 | 2.0 | 0.0 | 1.5 | 8.0 |
| | 1.5% | | | | | | |
| | Glycerol | | | | | | |
| 13 | TS9200 2% + | 5.4 | 4.0 | 2.0 | 0.0 | 2.0 | 8.0 |
| | 2% Glycerol | | | | | | |
| 14 | TS9200 2% + | 5.4 | 4.5 | 2.0 | 0.0 | 2.5 | 8.0 |
| | 2.5% | | | | | | |
| | Glycerol | | | | | | |
| 15 | TS9200 2% + | 5.4 | 5.0 | 2.0 | 0.0 | 3.0 | 8.0 |
| | 3% Glycerol | | | | | | |
| 16 | TS9200 2% + | 5.4 | 7.0 | 2.0 | 0.0 | 5.0 | 8.0 |
| | 5% Glycerol | | | | | | |
| 17 | TS9200 3% + | 5.4 | 4.0 | 3.0 | 0.0 | 1.0 | 8.0 |
| | 1% Glycerol | | | | | | |
| 18 | TS9200 3% + | 5.4 | 5.0 | 3.0 | 0.0 | 2.0 | 8.0 |
| | 2% Glycerol | | | | | | |
| 19 | TS9200 3% + | 5.4 | 6.0 | 3.0 | 0.0 | 3.0 | 8.0 |
| | 3% Glycerol | | | | | | |
| 20 | TS9200 2% + | 5.4 | 7.0 | 2.0 | 0.0 | 2.0 | 8.0 |
| | 3% pMDI + | | | | | | |
| | 2% Glycerol | | | | | | |
| 21 | TS9200 2% + | 5.4 | 7.0 | 2.0 | 0.0 | 2.0 | 8.0 |
| | 2% Glycerol + | | | | | | |
| | 3% pMDI | | | | | | |
| 22 | TS9200 2% + | 5.4 | 3.0 | 2.0 | 1.0 | 0.0 | 8.0 |
| | 1% Urea | | | | | | |
| 23 | TS9200 2% + | 5.4 | 5.0 | 2.0 | 3.0 | 0.0 | 8.0 |
| | 3% Urea | | | | | | |
| 24 | TS9200 2% + | 3.6 | 7.0 | 2.0 | 5.0 | 0.0 | 8.0 |
| | 5% Urea | | | | | | |
| 25 | TS9200 2% + | 5.9 | 4.0 | 2.0 | 1.0 | 1.0 | 8.0 |
| | 1% Glycerin + | | | | | | |
| | 1% Urea | | | | | | |
| 26 | 2% TS9200 + | 5.9 | 4.0 | 2.0 | 0.0 | 2.0 | 8.0 |
| | 2% Glycerin | | | | | | |
| 27 | 2% TS9200 + | 5.9 | 4.0 | 2.0 | 0.0 | 2.0 | 8.0 |
| | 2% Glycerin + | | | | | | |
| | 0.01 SMBS | | | | | | |
| 28 | 2% TS9200 + | 5.9 | 4.0 | 2.0 | 0.0 | 2.0 | 8.0 |
| | 2% Glycerin + | | | | | | |
| | 0.02 SMBS | | | | | | |
| 29 | 2% TS9200 + | 5.9 | 4.0 | 2.0 | 0.0 | 2.0 | 8.0 |
| | 2% Glycerin + | | | | | | |
| | 0.04 SMBS | | | | | | |

TABLE 2

| | | Performance | | | | | |
|---|---|---|---|---|---|---|---|
| | | Tack (in) | | | | | |
| | | | | | Average | | |
| | | Trial | Trial | Trial | of Trials | Stand. | Coeff. of |
| Sample | Components | 1 | 2 | 3 | 1-3 | Dev. | Variation |
| 1 | No | 0.5 | 0.5 | 0.5 | 0.5 | 0.0 | 0.0% |
| | Adhesive | | | | | | |
| | No | | | | | | |
| | Proteinaceous | | | | | | |
| | Powder | | | | | | |
| 2 | 3.0% pMDI | 1.0 | 1.1 | 1.0 | 1.0 | 0.1 | 5.6% |
| 3 | TS9200 Dry | 1.0 | 1.3 | N/A | 1.1 | 0.2 | 15.7% |
| | Flour | | | | | | |
| 4 | 1% Glycerol | 1.8 | 1.8 | 1.8 | 1.8 | 0.0 | 0.0% |
| 5 | 3% Glycerol | 1.8 | 1.5 | 1.5 | 1.6 | 0.1 | 9.1% |
| 6 | 5% Glycerol | 1.5 | 1.5 | 1.3 | 1.4 | 0.1 | 10.2% |
| 7 | TS9200 1% + | 2.0 | 2.3 | 2.3 | 2.2 | 0.1 | 6.7% |
| | 1% Glycerol | | | | | | |
| 8 | TS9200 1% + | 3.0 | 3.0 | 2.8 | 2.9 | 0.1 | 4.9% |
| | 2% Glycerol | | | | | | |
| 9 | TS9200 1% + | 2.3 | 2.0 | 2.5 | 2.3 | 0.3 | 11.1% |
| | 3% Glycerol | | | | | | |
| 10 | TS9200 2% + | 1.8 | 2.0 | 2.0 | 1.9 | 0.1 | 7.5% |
| | 0.5% | | | | | | |
| | Glycerol | | | | | | |
| 11 | TS9200 2% + | 3.0 | 3.3 | 3.0 | 3.1 | 0.1 | 4.7% |
| | 1% Glycerol | | | | | | |
| 12 | TS9200 2% + | 3.3 | 3.5 | 3.3 | 3.3 | 0.1 | 4.3% |
| | 1.5% Glycerol | | | | | | |
| 13 | TS9200 2% + | 3.8 | 3.8 | 3.5 | 3.7 | 0.14 | 3.9% |
| | 2% Glycerol | | | | | | |
| 14 | TS9200 2% + | 3.5 | 3.5 | 3.3 | 3.4 | 0.1 | 4.2% |
| | 2.5% Glycerol | | | | | | |
| 15 | TS9200 2% + | 3.0 | 2.8 | 2.8 | 2.8 | 0.1 | 5.1% |
| | 3% Glycerol | | | | | | |
| 16 | TS9200 2% + | 2.0 | 2.0 | 2.3 | 2.1 | 0.1 | 6.9% |
| | 5% Glycerol | | | | | | |
| 17 | TS9200 3% + | 3.0 | 3.0 | 2.8 | 2.9 | 0.1 | 4.9% |
| | 1% Glycerol | | | | | | |
| 18 | TS9200 3% + | 4.0 | 4.3 | 4.5 | 4.3 | 0.3 | 5.9% |
| | 2% Glycerol | | | | | | |
| 19 | TS9200 3% + | 3.8 | 4.0 | 3.8 | 3.8 | 0.1 | 3.8% |
| | 3% Glycerol | | | | | | |
| 20 | TS9200 2% + | 3.5 | 3.5 | 3.8 | 3.6 | 0.1 | 4.0% |
| | 3% pMDI + | | | | | | |
| | 2% Glycerol | | | | | | |
| 21 | TS9200 2% + | 4.0 | 4.0 | 3.8 | 3.9 | 0.1 | 3.7% |
| | 2% Glycerol + | | | | | | |
| | 3% pMDI | | | | | | |
| 22 | TS9200 2% + | 1.5 | 1.8 | 1.5 | 1.6 | 0.1 | 9.1% |
| | 1% Urea | | | | | | |
| 23 | TS9200 2% + | 4.0 | 3.8 | 4.0 | 3.9 | 0.1 | 3.7% |
| | 3% Urea | | | | | | |
| 24 | TS9200 2% | 5.5 | 5.5 | 5.3 | 5.4 | 0.1 | 2.7% |
| | 5% Urea | | | | | | |
| 25 | TS9200 2% + | 3.5 | 3.3 | 3.3 | 3.3 | 0.1 | 4.3% |
| | 1% Glycerin + | | | | | | |
| | 1% Urea | | | | | | |
| 26 | 2% TS9200 + | 3.8 | 3.5 | 3.5 | 3.6 | 0.1 | 4.0% |
| | 2% Glycerin | | | | | | |
| 27 | 2% TS9200 + | 4.0 | 3.8 | 4.0 | 3.9 | 0.1 | 3.7% |
| | 2% Glycerin + | | | | | | |
| | 0.01 SMBS | | | | | | |
| 28 | 2% TS9200 + | 4.0 | 4.0 | 4.3 | 4.1 | 0.1 | 3.5% |
| | 2% Glycerin + | | | | | | |
| | 0.02 SMBS | | | | | | |
| 29 | 2% TS9200 + | 3.5 | 3.5 | 3.3 | 3.4 | 0.1 | 4.2% |
| | 2% Glycerin + | | | | | | |
| | 0.04 SMBS | | | | | | |

TABLE 3

| | Average | Stand. |
|---|---|---|
| Sample | Tack | Dev. |
| Lignocellulosic Particles Only Control | 0.5 | 0.0 |
| 3% pMDI; 0% TS9200 Flour; 0% Glycerol | 1.0 | 0.1 |
| 0% pMDI; 3% TS9200 Flour; 0% Glycerol | 1.13 | 0.18 |
| 0% pMDI; 0% TS9200 Flour; 3% Glycerol | 1.58 | 0.14 |
| 0% pMDI; 2% TS9200 Flour; 2% Glycerol | 3.67 | 0.14 |
| 2% TS9200 Flour; 2% Glycerol; 3% pMDI | 3.92 | 0.14 |
| 2% TS9200 Flour; 3% pMDI; 2% Glycerol | 3.58 | 0.14 |

Relative to the last two entries in Table 3, the difference is in order of addition. In the first of the last two entries, flour was utilized first. Then the glycerol was added and then the pMDI. In the second of the last two entries, flour was again utilized first. Then pMDI was added and then the glycerol.

TABLE 4

| | | | Stand. |
|---|---|---|---|
| Sample | % Glycerol | Tack | Dev. |
| 0% TS9200 Flour; | 0.0 | 0.5 | 0.00 |
| 0% pMDI | 1.0 | 1.8 | 0.00 |
| | 3.0 | 1.6 | 0.14 |
| | 5.0 | 1.4 | 0.14 |
| 1% TS9200 Flour; | 1.0 | 2.2 | 0.14 |
| 0% pMDI | 2.0 | 2.9 | 0.14 |
| | 3.0 | 2.3 | 0.25 |
| 2% TS9200 Flour; | 0.5 | 1.9 | 0.14 |
| 0% pMDI | 1.0 | 3.1 | 0.14 |
| | 1.5 | 3.3 | 0.14 |
| | 2.0 | 3.7 | 0.14 |
| | 2.5 | 3.4 | 0.14 |
| | 3.0 | 2.8 | 0.14 |
| | 5.0 | 2.1 | 0.14 |
| 3% TS9200 Flour; | 0 | 1.1 | 0.18 |
| 0% pMDI | 1.0 | 2.9 | 0.14 |
| | 2.0 | 4.3 | 0.25 |
| | 3.0 | 3.8 | 0.14 |

TABLE 5

| | | | Stand. |
|---|---|---|---|
| Sample | % Urea | Tack | Dev. |
| 2% TS9200 Flour; | 1.0 | 1.6 | 0.14 |
| 0% pMDI | 3.0 | 3.9 | 0.14 |
| | 5.0 | 5.4 | 0.14 |

TABLE 6

| | % Sodium | | |
|---|---|---|---|
| | Metabisulfite | | Stand. |
| Sample | (SMBS) | Tack | Dev. |
| 2% TS9200 Flour; | 0.000 | 3.6 | 0.14 |
| 2% Glycerol | 0.010 | 3.9 | 0.14 |
| 0% pMDI | 0.020 | 4.1 | 0.14 |
| | 0.040 | 3.4 | 0.14 |

The data above, along with the data set forth in FIGS. 1-3, shows unexpectedly superior synergistic results rather than simple additive results relative to tack and green strength. In other words, these results generally show that the tacks/green strengths that result from the use of single components alone, and the values that are derived from simply adding the tacks/green strengths achieved from multiple single use components, are less than the tacks/green strengths that achieved through the synergistic action of the components. This is entirely unexpected, surprising, and superior to what would otherwise be expected by one of skill in the art.

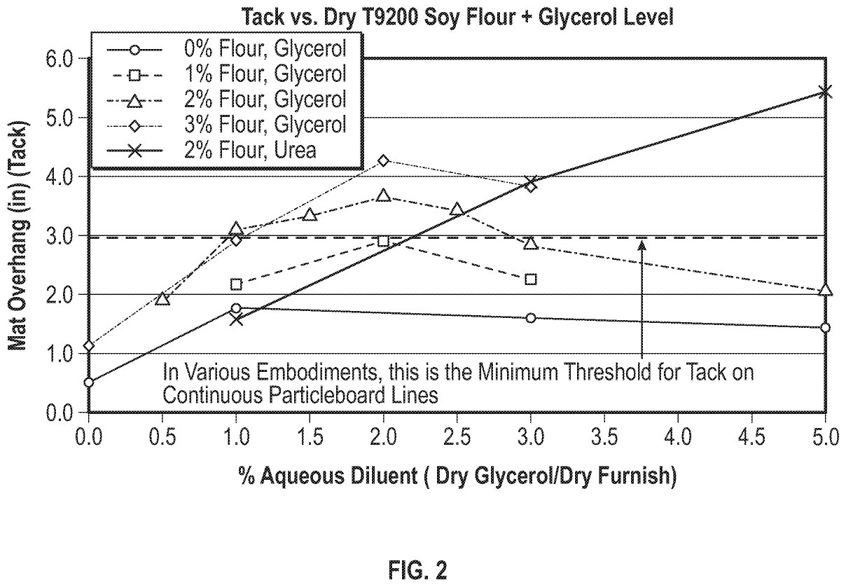

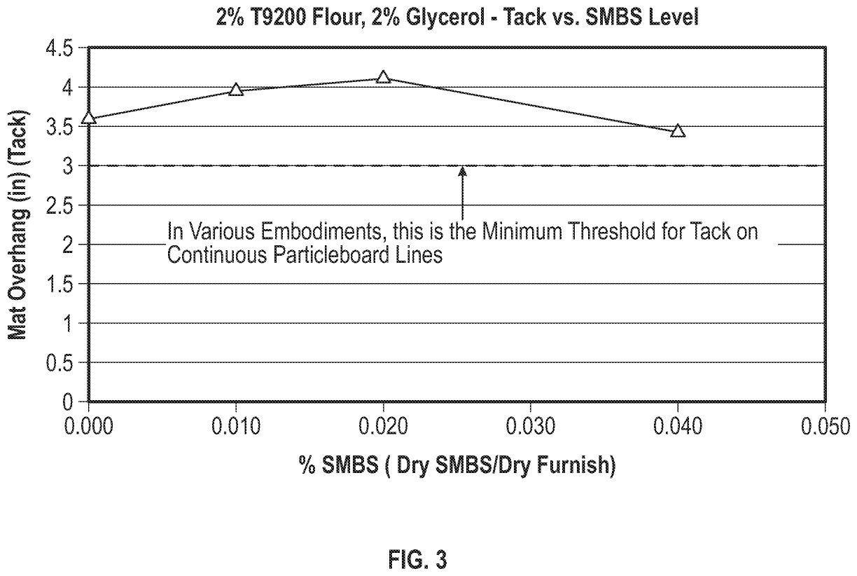

To be more specific, FIG. 1 shows controls and that the use of flour and aqueous diluent produces unexpectedly synergistic results, rather than additive. This Figure also shows that the addition of the proteinaceous powder with the adhesive surprisingly synergistically contributes to increased tack/green strength whether the adhesive is added before the diluent or after. Typically, the flour is added to the furnish first. FIG. 2 shows the effects of using different amounts of flour with different amounts of aqueous diluent as well as glycerol vs. urea. FIG. 3 focuses on use of sodium metabisulfite (SMBS) and shows that SMBS can be used to further boost tack and green strength.

Moreover, many of the Examples set forth above purposely exclude use of an adhesive, such as pMDI. This is done to focus the data on the performance of the proteinaceous powder and the aqueous diluent. Moreover, although some of the aforementioned examples perform well without an adhesive, typical commercial production processes would still utilize an adhesive due to hot-pressing requirements. For example, as shown in Table 3, the sample that includes 0% pMDI; 2% TS9200 Flour; and 2% Glycerol has a higher tack than some other examples. However, such an example would not typically be utilized in typical commercial production processes because such an example would likely not meet other physical property requirements. However, these aforementioned statements are not meant to limit this disclosure and formation of a mat without an adhesive is possible.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A unitary mat comprising:
A. a plurality of lignocellulosic particles;
B. an adhesive chosen from an isocyanate, phenol formaldehyde, polyamino amido epichlorohydrin, and combinations thereof and present in an amount of from about 1 to about 10 percent by weight based on 100 parts by weight of dry lignocellulosic particles;
C. a proteinaceous powder having a protein dispersibility index of from about 1 to about 90 and present in an amount of from about 0.5 to about 10 percent by weight based on 100 parts by weight of dry lignocellulosic particles; and
D. an aqueous diluent present in an amount of from about 0.5 to about 10 percent by weight based on 100 parts by weight of dry lignocellulosic particles.

2. The unitary mat of claim 1 wherein said proteinaceous powder is soy flour.

3. The unitary mat of claim 2 wherein said soy flour has a protein dispersibility index of from about 70 to about 90.

4. The unitary mat of claim 1 wherein said proteinaceous powder has a protein dispersibility index of from about 70 to about 90.

5. The unitary mat of claim 1 wherein said proteinaceous powder is chosen from soy flour, soy concentrate, soy isolate, canola flour, wheat flour, cottonseed flour, peanut flour, corn flour, pea flour, almond flour, buckwheat flour, and combinations thereof.

6. The unitary mat of claim 1 wherein said adhesive is polymeric 4,4′-methylene diphenyl isocyanate.

7. The unitary mat of claim 1 wherein said adhesive is phenol formaldehyde.

8. The unitary mat of claim 1 wherein said adhesive is polyamino amido epichlorohydrin.

9. The unitary mat of claim 1 wherein said aqueous diluent is chosen from glycerol, glycerol derivatives, monomeric and polymeric ethylene glycol, monomeric and polymeric propylene glycol, sorbitol, sucrose, high fructose corn syrup, urea, thiourea, guanidine hydrochloride, sodium dodecyl sulfate, 2-methoxyethanol, ethylene carbonate, propylene carbonate, methyl pyrrolidone, lactose, maltodextrin, cyclodextrin, a carbohydrate, syrups, hydrolyzed polysaccharides, and combinations thereof.

10. The unitary mat of claim 1 wherein said aqueous diluent is urea.

11. The unitary mat of claim 1 wherein said aqueous diluent is glycerol.

12. The unitary mat of claim 1 wherein said adhesive is present in an amount of from about 2 to about 3 percent by weight based on 100 parts by weight of dry lignocellulosic particles.

13. The unitary mat of claim 1 wherein said proteinaceous powder is present in an amount of from about 2 to about 3 percent by weight based on 100 parts by weight of dry lignocellulosic particles.

14. The unitary mat of claim 1 further comprising sodium metabisulfite.

15. A unitary mat comprising:
A. a plurality of lignocellulosic particles;
B. polymeric 4,4′-methylene diphenyl isocyanate present in an amount of from about 1 to about 10 percent by weight based on 100 parts by weight of dry lignocellulosic particles;
C. soy flour having a protein dispersibility index of from about 70 to about 90 and present in an amount of from about 2 to about 3 percent by weight based on 100 parts by weight of dry lignocellulosic particles; and
D. an aqueous diluent chosen from glycerol, urea, and combinations thereof and present in an amount of from about 2 to about 3 percent by weight based on 100 parts by weight of dry lignocellulosic particles;
wherein said unitary mat has a green strength tack test result of greater than 3 inches.

16. A continuous process for forming a unitary mat on a line having at least two conveyors spaced from each other, said process comprising the steps of:
A. combining an adhesive, a proteinaceous powder, a diluent and a plurality of lignocellulosic particles to form a mixture;
B. forming the unitary mat from the mixture on a first conveyer; and
C. transferring the unitary mat from the first conveyor to a second conveyor across a distance while maintaining structural integrity of the unitary mat;
wherein the adhesive is chosen from an isocyanate, phenol formaldehyde, polyamino amido epichlorohydrin, and combinations thereof and is present in the unitary mat in an amount of from about 1 to about 10 percent by weight based on 100 parts by weight of dry lignocellulosic particles;
wherein the proteinaceous powder has a protein dispersibility index of from about 1 to about 90 and is present in the unitary mat in an amount of from about 0.5 to about 10 percent by weight based on 100 parts by weight of dry lignocellulosic particles; and
wherein the aqueous diluent is present in the unitary mat in an amount of from about 0.5 to about 10 percent by weight based on 100 parts by weight of dry lignocellulosic particles.

17. The method of claim 16 wherein the proteinaceous powder is soy flour.

18. The method of claim 16 wherein the proteinaceous powder has a protein dispersibility index of from about 70 to about 90.

19. The method of claim 16 wherein the proteinaceous powder is chosen from soy flour, soy concentrate, soy isolate, canola flour, wheat flour, cottonseed flour, peanut flour, corn flour, pea flour, almond flour, buckwheat flour, and combinations thereof.

20. The method of claim 16 wherein the adhesive is polymeric 4,4′-methylene diphenyl isocyanate and the aqueous diluent is chosen from urea, glycerol, and combinations thereof.
